(19) United States
(12) Patent Application Publication
(10) Pub. No.: US 2016/0075318 A1
(43) Pub. Date: Mar. 17, 2016

(54) BRAKE DEVICE FOR VEHICLE

(71) Applicant: HYUNDAI MOBIS CO., LTD., Seoul (KR)

(72) Inventors: Sung Ki AHN, Seoul (KR); Soung Jun PARK, Ansan-si (KR)

(21) Appl. No.: 14/686,686

(22) Filed: Apr. 14, 2015

(30) Foreign Application Priority Data
Sep. 12, 2014 (KR) 10-2014-0120876

(51) Int. Cl. B60T 13/66; B60T 13/16

(52) U.S. Cl. CPC B60T 13/66; B60T 13/161

(57) ABSTRACT

A brake device for a vehicle may include: a master cylinder amplifying oil pressure; a pedal driving the master cylinder; an oil pressure guide part guiding the oil pressure generated from the master cylinder to a wheel cylinder; an electric motor pump supplying oil to the oil pressure guide part; and an auxiliary supply part supplying oil to the electric motor pump.

### CROSS-REFERENCES TO RELATED APPLICATIONS

The present application claims priority to Korean application number 10-2014-0120876, filed on Sep. 12, 2014, which is incorporated by reference in its entirety.

### BACKGROUND

The present disclosure relates to a brake device for a vehicle, and more particularly, to a brake device for a vehicle, which is capable of improving braking performance by additionally supplying oil to a system during an emergency braking event.

In general, a brake device refers to a device which decelerates or stops a vehicle. When a driver steps on a brake pedal, oil pressure is amplified in a master cylinder, and oil is supplied to a wheel cylinder to provide a braking force to each wheel. Furthermore, when a motor pump is driven as the pressurization for the pedal is detected, the oil pressure may be amplified and provided to the wheel cylinder.

Recently, as the AEB (autonomous emergency braking) function is implemented in more and more vehicles, the stability of the vehicles has been improved. The vehicles with the AEB function can perform a braking operation by recognizing surrounding situations through various sensors.

The related art is disclosed in Korean Patent Laid-open Publication No. 2011-0065845 published on Jun. 16, 2011 and entitled “Brake system for a vehicle”.

### SUMMARY

Embodiments of the present invention are directed to a brake device for a vehicle, which is capable of improving braking performance by rapidly supplying oil during an emergency braking event.

In one embodiment, a brake device for a vehicle may include: a master cylinder amplifying oil pressure; a pedal driving the master cylinder; an oil pressure guide part guiding the oil pressure generated from the master cylinder to a wheel cylinder; an electric motor pump supplying oil to the oil pressure guide part; and an auxiliary supply part supplying oil to the electric motor pump.

The auxiliary supply part may include: a housing part having a storage chamber which stores oil and an entry and exit hole which communicates with the storage chamber so as to transfer oil; a receiving part formed in the housing part and fixed and arranged in the storage chamber; a piston part adjusting the volume of the storage chamber; a restoring part arranged in the storage chamber so as to elastically support the piston part; a rod part connected to the piston part; and a driving part mounted on the housing part so as to surround the rod part, and generating an electromagnetic field to move the rod part toward the piston part, as power is applied.

The receiving part may include: a disk-shaped closing plate closing the storage chamber; and a closing protrusion protruding from the edge of the closing plate so as to be closely attached to the inner surface of the storage chamber.

The piston part may include: a connection body coupled to the rod part; a protrusion body protruding from the edge of the connection body toward the receiving part; and a sealing body inserted into a protrusion groove formed in the protrusion body, and closely attached to the inner surface of the housing part so as to block oil leakage.

The brake device may further include: a sensor sensing a surrounding environment of the vehicle; and a controller receiving a sensing signal of the sensor so as to control the electric motor pump and the auxiliary supply part.

The controller may drive the auxiliary supply part when the electric motor pump is initially driven.

Even when the pedal is not stepped on, the controller may drive the electric motor pump and the auxiliary supply part to supply oil to the wheel cylinder, based on the sensing signal received from the sensor.

The oil pressure guide part may include: an oil pipe for guiding oil; and a plurality of oil valves for opening and closing the oil pipe.

When the pedal is stepped on during a general braking operation, oil supplied through the electric motor pump may be provided to the wheel cylinder, and when the pedal is stepped on during an error braking operation, oil supplied from the master cylinder may be provided to the wheel cylinder.

The auxiliary supply part may be mounted on the electric motor pump.

During a general braking event, the electric motor pump may be driven to supply oil to the wheel cylinder, and during an emergency braking event, the auxiliary supply part may supply oil to the electric motor pump so as to increase the pressure of the oil generated from the electric motor pump.

### BRIEF DESCRIPTION OF THE DRAWINGS

FIG. 1 is a diagram schematically illustrating a brake device for a vehicle in accordance with an embodiment of the present invention.

FIG. 2 is a diagram schematically illustrating a flow of oil during a general braking event in the brake device for a vehicle in accordance with the embodiment of the present invention.

FIG. 3 is a diagram schematically illustrating a flow of oil during an emergency braking event in the brake device for a vehicle in accordance with the embodiment of the present invention.

FIG. 4 is a diagram schematically illustrating a state in which no power is applied to an auxiliary supply unit in the brake device for a vehicle in accordance with the embodiment of the present invention.

FIG. 5 is a diagram schematically illustrating a state in which power is applied to the auxiliary supply unit in the brake device for a vehicle in accordance with the embodiment of the present invention.

FIG. 6 is a diagram schematically illustrating a state in which the auxiliary supply part is mounted on an electric motor pump in the brake device for a vehicle in accordance with the embodiment of the present invention.

FIGS. 7A and 7B are graphs comparatively illustrating the oil pressure of the brake device for a vehicle in accordance with the embodiment of the present invention and the oil pressure of a brake device for a vehicle, from which the auxiliary supply part is excluded.

### DESCRIPTION OF EMBODIMENTS

Embodiments of the invention will hereinafter be described in detail with reference to the accompanying drawings. It should be noted that the drawings are not to precise scale and may be exaggerated in thickness of lines or sizes of components for descriptive convenience and clarity only. Furthermore, the terms as used herein are defined by taking functions into account and can be changed according to the custom or intention of users or operators. Therefore, definition of the terms should be made according to the overall disclosures set forth herein.

In a vehicle, when AEB function is performed, the motor pump forcibly suctions brake oil and supplies amplified oil pressure to the wheel cylinder. At this time, when the motor pump is driven, the brake oil stored in a storage unit is forcibly introduced into the motor pump through the master cylinder and a brake piping.

Oil pressure has been amplified through the motor pump. However, due to the influence of the shape and length of a flow path for oil supplied at the initial stage of an emergency braking operation and the viscosity of oil at each temperature, the oil may not be smoothly supplied to the motor pump. When the oil is not smoothly supplied to the motor pump, a satisfactory level of oil pressure would not be supplied to the wheel cylinder. In this case, the braking performance may be degraded.

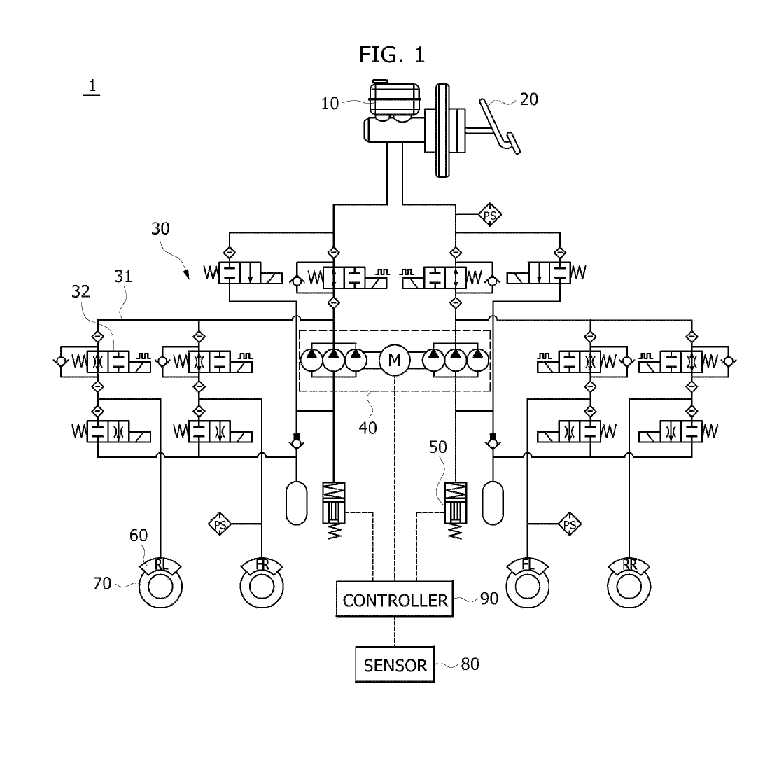

FIG. 1 is a diagram schematically illustrating a brake device for a vehicle in accordance with an embodiment of the present invention. Referring to FIG. 1, the brake device 1 for a vehicle in accordance with the embodiment of the present invention may include a master cylinder 10, a pedal 20, an oil pressure guide part 30, an electric motor pump 40, and an auxiliary supply part 50.

The master cylinder 10 may be mounted on a vehicle body, and the pedal 20 may drive the master cylinder 10. For example, the pedal 20 may be positioned at the bottom of a driver's seat such that a driver can step on the pedal 20. When the pedal 20 pressurizes the master cylinder 10, oil pressure in the master cylinder 10 may be amplified.

The oil pressure guide part 30 may guide the oil pressure generated through the master cylinder 10 to wheel cylinders 60. For example, the vehicle may include four wheels 70, and the oil pressure guide part 30 may supply oil pressure to the wheel cylinders 60 to brake the respective wheels 70. In the present embodiment, the oil pressure guide part 30 may include an oil pipe 31 for guiding oil and a plurality of oil valves 32 for opening/closing the oil pipe 31.

The electric motor pump 40 may supply oil to the oil pressure guide part 30, and the oil supplied to the oil pressure guide part 30 may be provided to the wheel cylinder 60 to brake the wheel 70. For example, the electric motor pump 40 may be connected to the oil pipe 31. When the pedal 20 is stepped on during a general braking event, the oil supplied through the electric motor pump 40 may be provided to the wheel cylinder 60. Furthermore, when the pedal 20 is stepped on during an error braking event in which the valves cannot be operated, the oil supplied from the master cylinder 10 may be provided to the wheel cylinder 60.

The auxiliary supply part 50 may supply oil to the electric motor pump 40. When the oil is supplied to the electric motor pump 40 through the auxiliary supply part 50, a pressure amplification ratio of oil discharged through the electric motor pump 40 may be increased. Then, since the oil is rapidly supplied to the wheel cylinder 60, the braking response can be improved.

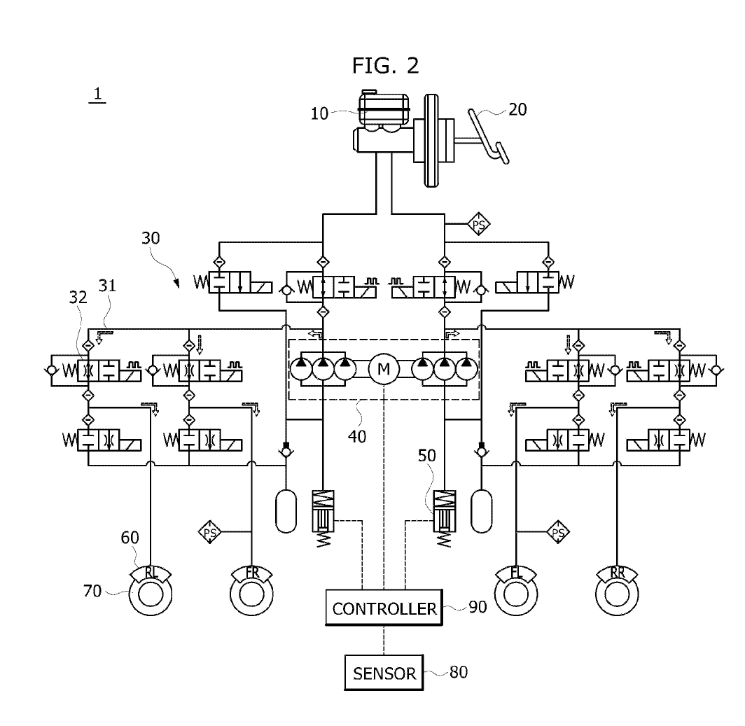

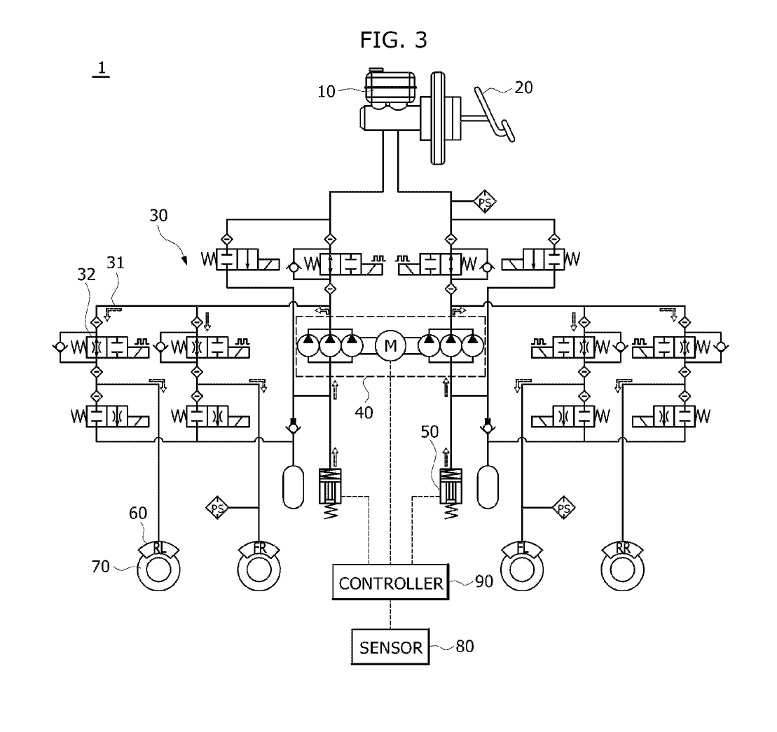

FIG. 2 is a diagram schematically illustrating a flow of oil during a general braking event in the brake device for a vehicle in accordance with the embodiment of the present invention. FIG. 3 is a diagram schematically illustrating a flow of oil during an emergency braking event in the brake device for a vehicle in accordance with the embodiment of the present invention. Referring to FIGS. 1 to 3, during a general braking event, the electric motor pump 40 may be driven to supply oil to the wheel cylinders 60. Furthermore, during an emergency braking event, the auxiliary supply part 50 may supply oil to the electric motor pump 40 such that the pressure of oil generated through the electric motor pump 40 can be increased.

The brake device 1 for a vehicle in accordance with the embodiment of the present invention may further include a sensor 80 and a controller 90. The sensor 80 may sense the surrounding environment of the vehicle, and the controller 90 may receive a detection signal of the sensor 80, and control the electric motor pump 40 and the auxiliary supply part 50.

For example, the sensor 80 may sense an object around the vehicle, and transmit a sensing signal to the controller 90. Although a driver does not step on the pedal 20, the controller 90 may drive the electric motor pump 40 and the auxiliary supply part 50 based on the received sensing signal, and supply oil to the wheel cylinder 60. As such, when the controller 90 independently performs a braking operation in a situation where the driver does not recognize the braking operation, the braking operation may correspond to an emergency braking operation.

The controller 90 may drive the auxiliary supply part 50 when the electric motor pump 40 is initially driven. For example, when the electric motor pump 40 and the auxiliary supply part 50 are simultaneously driven during an emergency braking event, a sufficient amount of oil may be supplied to the electric motor pump 40 so as to improve the oil pressure boosting performance of the electric motor pump 40. When the oil pressure boosting performance of the electric motor pump 40 is improved, a sufficient amount of oil may be supplied to the wheel cylinders 60. Then, the braking force at the initial stage of the emergency braking operation can be improved.

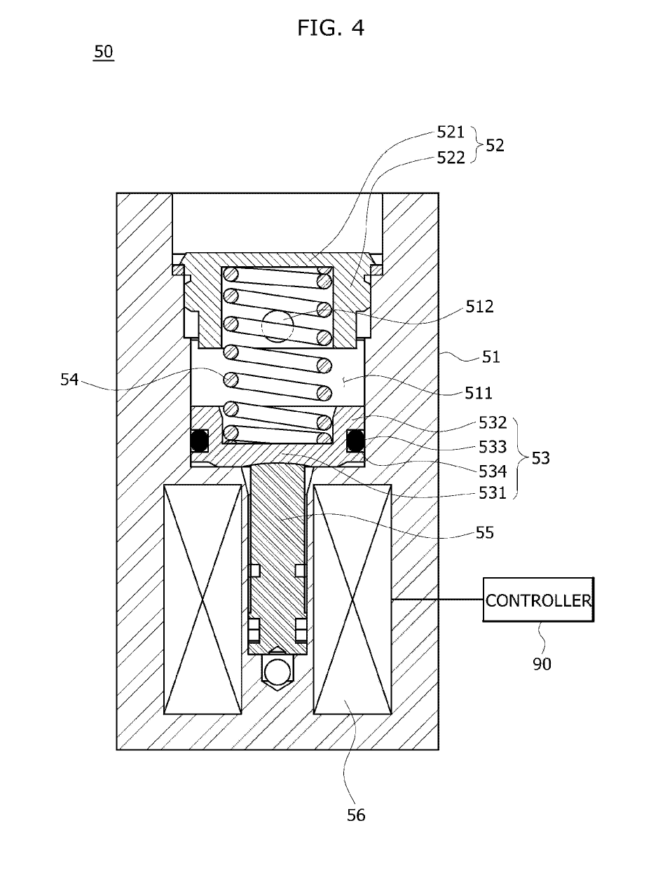

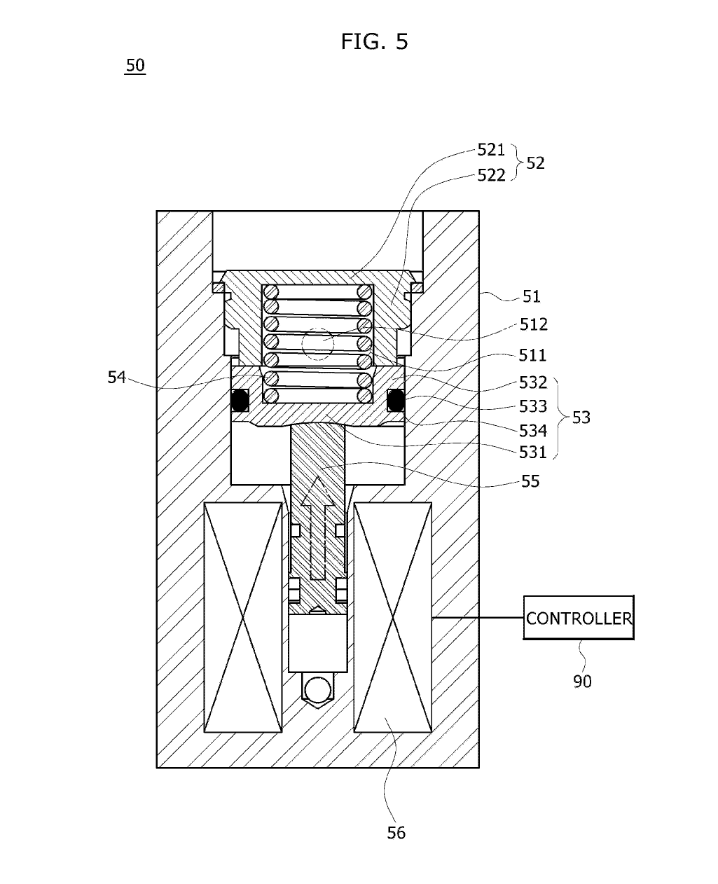

FIG. 4 is a diagram schematically illustrating a state in which no power is applied to the auxiliary supply unit in the brake device for a vehicle in accordance with the embodiment of the present invention. FIG. 5 is a diagram schematically illustrating a state in which power is applied to the auxiliary supply unit in the brake device for a vehicle in accordance with the embodiment of the present invention. Referring to FIGS. 4 and 5, the auxiliary supply part 50 in accordance with the embodiment of the present invention may include a housing part 51, a receiving part 52, a piston part 53, a restoring part 54, a rod part 55, and a driving part 56.

The housing part 51 may have a storage chamber 511 to store oil. The housing part 51 may have an entry and exit hole 512 which communicates with the storage chamber 511 so as to transfer oil. For example, the housing part 51 may be fixed to the vehicle body, and have a hollow cylindrical shape.

The receiving part 52 may be formed in the housing part 51, and fixed and arranged in the storage chamber 511. In the present embodiment, the receiving part 52 may include a disk-shaped closing plate 521 and a closing protrusion 522. The closing plate 521 may close the storage chamber 511, and the closing protrusion 522 may protrude from the edge of the closing plate 521 so as to be closely attached to the inner wall of the storage chamber 511.

The piston part 53 may be movably arranged in the storage chamber 511 so as to adjust the volume of the storage chamber 511. For example, the piston part 53 may be arranged to face the receiving part 52, and oil may be stored in a space formed between the piston part 53 and the receiving part 52.

The restoring part 54 may be arranged in the storage chamber 511 so as to elastically support the piston part 53. For example, the restoring part 54 may be formed in a coil spring shape, and arranged between the piston part 53 and the receiving part 52 so as to support the piston part 53 and the receiving part 52.

The rod part 55 may be connected to the piston part 53, and the driving part 56 may be mounted in the housing part 51 so as to surround the rod part 55. As power is applied according to control of the controller 90, the driving part 56 may generate an electromagnetic field to move the rod part 55 toward the piston part 53. Furthermore, the driving part 56 may employ various parts capable of reducing the response time of the rod part 55.

The piston part 53 in accordance with the embodiment of the present invention may include a connection body 531, a protrusion body 532, and a sealing body 533. The connection body 531 may be coupled to an end of the rod part 55, and formed in a disk shape to close the storage chamber 511. The connection body 531 may be arranged to face the closing plate 521. The protrusion body 532 may protrude from the edge of the connection body 531 toward the receiving part 52. The sealing body 533 may be inserted into a protrusion groove 534 formed in the protrusion body 532, and closely attached to the inner surface of the housing part 51, that is, the wall surface forming the storage chamber 511 so as to block oil leakage.

When the driving part 56 is driven, the protrusion body 532 may be moved until the protrusion body 532 comes in contact with the receiving part 52. That is, the movement of the protrusion body 532 may be restricted when the protrusion body 532 comes in contact with the receiving part 52. As the piston part 53 including the protrusion body 532 is moved, the volume of the storage chamber 511 may be reduced. Then, oil corresponding to the reduction of the volume may be discharged from the housing part 51. Thus, as the discharge amount of oil is adjusted according to the designed length of the protrusion body 523, it is possible to prevent the electric motor pump 40 from supplying oil more or less than necessary.

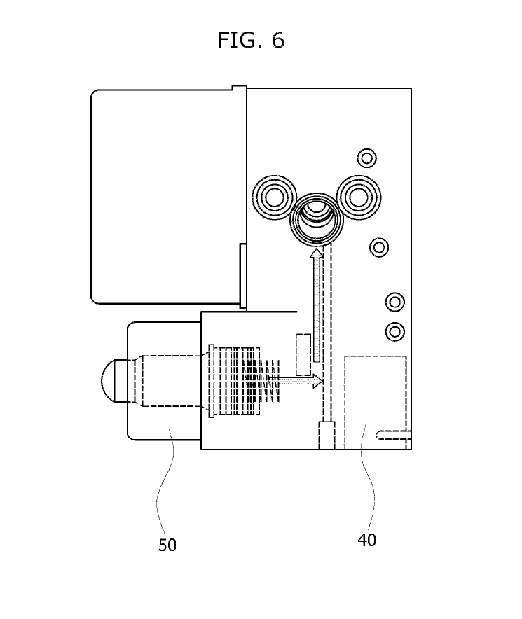

FIG. 6 is a diagram schematically illustrating a state in which the auxiliary supply part is mounted on the electric motor pump in the brake device for a vehicle in accordance with the embodiment of the present invention. Referring to FIG. 6, the auxiliary supply part 50 in accordance with the embodiment of the present invention may be mounted on the electric motor pump 40. For example, the pair of auxiliary supply parts 50 may be installed in the electric motor pump 40 so as to form an integrated module. At this time, since the oil discharged from the auxiliary supply part 50 is supplied to the pump of the electric motor pump 40 through an internal flow path of the electric motor pump 40, the length of the flow path through which the oil can flow may be decreased to reduce a resistance loss.

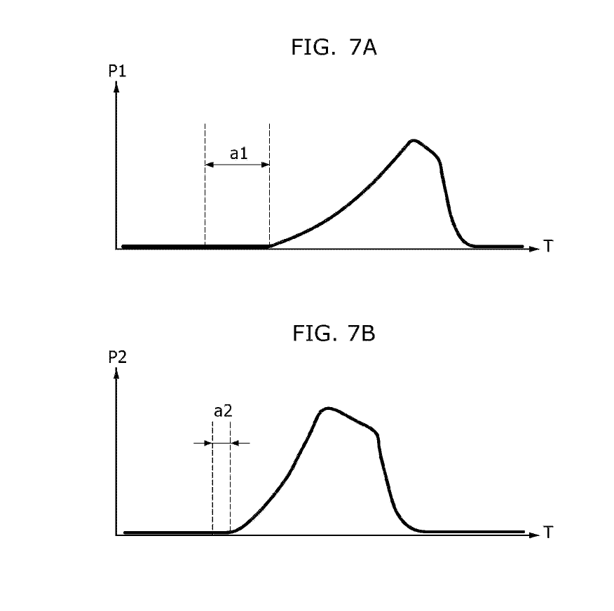

FIGS. 7A and 7B are graphs comparatively illustrating the oil pressure of the brake device for a vehicle in accordance with the embodiment of the present invention and the oil pressure of a brake device for a vehicle, from which the auxiliary supply part is excluded. Referring to FIGS. 6 and 7, when the auxiliary supply part 50 is not included in the electric motor pump 40 (refer to 7A), a first oil pressure P1 may rise after a first delay time al which is required until oil pressure is amplified after a control signal is generated from the controller 90. Furthermore, when the auxiliary supply part 50 is included in the electric motor pump 40 (refer to 7B), a second oil pressure P2 may rise after a second delay time a2 which is required until the oil pressure is amplified after a control signal is generated from the controller 90. At this time, the second delay time a2 is shorter than the first delay time a1, and the first oil pressure P1 rises at higher speed than the second oil pressure P2. Thus, when the auxiliary supply part 50 is included in the electric motor pump 40, oil pressure may be more rapidly amplified to improve the braking response.

The operation of the brake device for a vehicle in accordance with the embodiment of the present invention will be described as follows.

When a driver steps on the pedal 20 during a general braking event, the electric motor pump 40 may be driven, and oil of which the pressure is raised by the electric motor pump 40 may be provided to the wheel cylinder 60 through the oil pressure guide part 30 (refer to FIG. 2). At this time, since no power is applied to the auxiliary supply part 50, the receiving part 52 and the piston part 53 may be isolated from each other (refer to FIG. 4).

When the sensor 80 senses surrounding risk and transmits a sensing signal to the controller 90, the electric motor pump 40 may be driven to amplify the oil pressure according to control of the controller 90. Furthermore, the auxiliary supply part 50 of the controller 90 may supply oil to the electric motor pump 40 (refer to FIG. 3).

That is, when power is supplied to the driving part 56 according to the control of the controller 90, the rod part 55 may move the piston part 53 toward the receiving part 52. At this time, the restoring part 54 which elastically supports the piston part 53 may be contracted. Then, when the power applied to the driving part 56 is released, the restoring part 54 may provide a restoring force to the piston part 53. When the piston part 53 is moved to reduce the volume of the storage chamber 511, oil corresponding to the reduced volume of the storage chamber 511 may be supplied to the electric motor pump 40 (refer to FIG. 5).

When the auxiliary supply part 50 additionally supplies oil to the electric motor pump 40, the oil pressure boosting performance of the electric motor pump 40 may be improved to smoothly supply oil to the wheel cylinders 60.

In accordance with the embodiment of the present invention, as the auxiliary supply part additionally supplies oil to the electric motor pump, the braking performance of the brake device can be improved.

Furthermore, when the sensor senses a risk of the vehicle, the controller may drive the electric motor pump and the auxiliary supply part such that a braking operation for the vehicle is automatically induced.

Furthermore, when the electric motor pump is initially driven, the auxiliary supply part may be driven to supply oil. Thus, the braking performance at the initial stage can be improved, and the response time can be reduced.

Although embodiments of the invention have been disclosed for illustrative purposes, those skilled in the art will appreciate that various modifications, additions and substitutions are possible, without departing from the scope and spirit of the invention as defined in the accompanying claims.

What is claimed is:

1. A brake device for a vehicle, comprising:
a master cylinder amplifying oil pressure;
a pedal driving the master cylinder;
an oil pressure guide part guiding the oil pressure generated from the master cylinder to a wheel cylinder;
an electric motor pump supplying oil to the oil pressure guide part; and
an auxiliary supply part supplying oil to the electric motor pump.

2. The brake device of claim 1, wherein the auxiliary supply part comprises:
a housing part having a storage chamber which stores oil and an entry and exit hole which communicates with the storage chamber so as to transfer oil;
a receiving part formed in the housing part and fixed and arranged in the storage chamber;
a piston part adjusting the volume of the storage chamber;
a restoring part arranged in the storage chamber so as to elastically support the piston part;
a rod part connected to the piston part; and
a driving part mounted on the housing part so as to surround the rod part, and generating an electromagnetic field to move the rod part toward the piston part, as power is applied.

3. The brake device of claim 2, wherein the receiving part comprises:
a disk-shaped closing plate closing the storage chamber; and
a closing protrusion protruding from the edge of the closing plate so as to be closely attached to the inner surface of the storage chamber.

4. The brake device of claim 2, wherein the piston part comprises:
a connection body coupled to the rod part;
a protrusion body protruding from the edge of the connection body toward the receiving part; and
a sealing body inserted into a protrusion groove formed in the protrusion body, and closely attached to the inner surface of the housing part so as to block oil leakage.

5. The brake device of claim 1, further comprising:
a sensor sensing a surrounding environment of the vehicle; and
a controller receiving a sensing signal of the sensor so as to control the electric motor pump and the auxiliary supply part.

6. The brake device of claim 5, wherein the controller drives the auxiliary supply part when the electric motor pump is initially driven.

7. The brake device of claim 5, wherein even when the pedal is not stepped on, the controller drives the electric motor pump and the auxiliary supply part to supply oil to the wheel cylinder, based on the sensing signal received from the sensor.

8. The brake device of claim 1, wherein the oil pressure guide part comprises:
an oil pipe for guiding oil; and
a plurality of oil valves for opening and closing the oil pipe.

9. The brake device of claim 8, wherein when the pedal is stepped on during a general braking operation, oil supplied through the electric motor pump is provided to the wheel cylinder, and
when the pedal is stepped on during an error braking operation, oil supplied from the master cylinder is provided to the wheel cylinder.

10. The brake device of claim 1, wherein the auxiliary supply part is mounted on the electric motor pump.

11. The brake device of claim 1, wherein during a general braking event, the electric motor pump is driven to supply oil to the wheel cylinder, and
during an emergency braking event, the auxiliary supply part supplies oil to the electric motor pump so as to increase the pressure of the oil generated from the electric motor pump.
